(19) United States
(12) Patent Application Publication
(10) Pub. No.: US 2014/0281499 A1
(43) Pub. Date: Sep. 18, 2014

(54) METHOD AND SYSTEM FOR ENABLING COMMUNICATIONS BETWEEN UNRELATED APPLICATIONS

(71) Applicant: OpenPeak Inc., Boca Raton, FL (US)

(72) Inventors: Philip Schentrup, Parkland, FL (US); Christopher Michael Wade, Delray Beach, FL (US)

(21) Appl. No.: 13/942,042

(22) Filed: Jul. 15, 2013

Related U.S. Application Data
(60) Provisional application No. 61/791,787, filed on Mar. 15, 2013.

(51) Int. Cl. H04L 29/06; G06F 12/14

(52) U.S. Cl. CPC H04L 63/0823; G06F 12/1408
USPC 713/156; 713/193

(57) ABSTRACT

A method and system of enabling communications among unrelated applications is described herein. The method includes the step of identifying a paste memory element in an environment of a computing device that restricts communications among unrelated applications. The method also includes the step of imposing a file system on the identified paste memory element. The file system is compatible with the unrelated applications such that a first unrelated application is capable of storing data in the paste memory element using the imposed file system and a second unrelated application is capable of accessing the stored data using the imposed file system. As an example, the first and second unrelated applications may be secure applications. In addition, the method can also include the steps of encrypting the data stored in the paste memory element that is associated with the first unrelated application and decrypting this data on behalf of the second unrelated application.

### CROSS-REFERENCE TO RELATED APPLICATIONS

This patent application claims priority to U.S. Patent Application No. 61/791,787, filed on Mar. 15, 2013, which is incorporated herein by reference in its entirety.

### FIELD OF TECHNOLOGY

The present description relates to systems and methods for enabling communications between applications and in particular, communications between applications that are unrelated.

### BACKGROUND

Many mobile communication devices have the ability to download and install applications, or apps, to increase their usefulness. Most of the apps that are installed on these devices are available at electronic storefronts known colloquially as app stores. To foster the sale of mobile communication devices and apps, the operators of the app stores have made it easy for app developers to upload their apps to the app stores. As such, there are a tremendous number of apps available from a litany of app developers at these app stores.

Because the apps may come from so many different sources, the security of the mobile devices, as well as the apps themselves, is an important issue. As such, precautions must be taken to safeguard against apps that contain malware or other malicious code. For example, apps that are installed on a mobile device may be “sandboxed,” a condition in which communications between apps is restricted. Even so, some communications between apps in this arrangement may be permitted. For example, a URL in one app may enable a user to link to another app, and the operating system may allow copy-and-paste operations between the apps. These minor data exchanges, however, are not performed in a secure manner. Thus, a need exists to enable apps to communicate securely with one another without jeopardizing or disabling the safeguards that are already in place for their protection.

### SUMMARY

A method of enabling communications among unrelated applications is described herein. Specifically, in an environment of a computing device that restricts communications among unrelated applications, a paste memory element can be identified. In addition, a file system can be imposed on the identified paste memory element. The file system may be compatible with the unrelated applications such that a first unrelated application is capable of storing data in the paste memory element using the imposed file system and a second unrelated application is capable of accessing the stored data using the imposed file system. The term “among,” as it is used throughout this description, should not be interpreted as requiring data exchanges among three or more unrelated applications, irrespective of grammar rules.

As an example, the identified paste memory element is a general memory element that can be part of the computing device or a custom memory element that is created as part of identifying the paste memory element. A namespace may also be imposed on the custom memory element.

In one arrangement, the first unrelated application may be further capable of storing encrypted data in the paste memory element using the imposed file system, and the second unrelated application may be further capable of accessing the encrypted stored data using the imposed file system. The method can further include the step of providing a key to the second unrelated application or generating the key through the second unrelated application to enable the second unrelated application to access the encrypted stored data.

In one example, the first unrelated application and the second unrelated application may be secure applications. In another example, the first unrelated application may have a certificate that is signed by a first entity, and the second unrelated application may have a certificate that is signed by a second entity.

The paste memory element, for example, can be a persistent paste memory element such that data stored in the paste memory element survives a rebooting process. The method can also include the step of segmenting the paste memory element into a plurality of data blocks, and the file system imposed on the paste memory element may be structured as a corresponding block file system. As another example, data that is stored in the identified paste memory element comprises configuration data that at least includes policies that are related to the operation of the first unrelated application or the second unrelated application.

Another method of enabling communications among unrelated applications is described herein. The method can include the steps of installing a first application on a computing device, installing a second application on the computing device and storing data associated with the first application in a paste memory element through a file system imposed on the paste memory element. The method can also include the step of accessing the stored data using the second application through the file system imposed on the paste memory element. The first application and the second application may be unrelated applications, and the computing device may be configured to restrict communications between unrelated applications. As such, this method can enable data exchange between unrelated applications, even in the restricted environment of the computing device.

The method can also include the step of encrypting the data to be stored in the paste memory element that is associated with the first unrelated application. In one arrangement, the stored data may be decrypted as part of accessing the stored data using the second unrelated application. As an example, the first application may have a certificate that is signed by a first entity, and the second application may have a certificate that is signed by a second entity.

As another example, the file system can be a block file system, and the paste memory element can be segmented into multiple data blocks. The paste memory element may also be a persistent paste memory element. As another example, the first application and the second application may be secure applications that have been modified to increase their functionality over their original designs. The method may also include the steps of capturing a snapshot of data stored in the paste memory element and saving a copy of the snapshot of data to a remote location.

Yet another method of enabling communications among unrelated applications is described herein. The method can include the steps of writing data to a memory element with a first unrelated application and accessing the data from the memory element with a second unrelated application. The first unrelated application and the second unrelated application may be installed on a computing device that presents an environment in which unrelated applications are restricted from sharing data with one another. Moreover, a file system can be imposed on the memory element to facilitate the exchange of data between the first unrelated application and the second unrelated application.

The data that is written to the memory element from the first unrelated application can be encrypted, and the data that is accessed from the memory element that is accessed by the second memory element can be decrypted. As an example, the memory element can be a paste memory element that enables copy and paste operations on the computing device.

In one embodiment, the first unrelated application and the second unrelated application may be secure applications. In another embodiment, the first unrelated application and the second unrelated application may be re-mapped to interact with the file system imposed on the memory element. A namespace may also be imposed on the memory element.

A method of enabling communications among applications is described herein. The method can include the step of identifying a paste memory element, encrypting data from a first unrelated application, storing the encrypted data in the paste memory element and accessing and decrypting the stored data for a second unrelated application. As an example, the first and second unrelated applications may be unrelated in that they do not share certain permissions or privileges with respect to other applications or services. In one arrangement, a file system may be imposed on the identified paste memory element, and both the first and second unrelated applications may be compatible with the file system. This arrangement can allow for the secure sharing of information among a plurality of applications, even unrelated applications, such as those that have been identified as being authorized to do so. Thus, a common, globally-shared memory can be converted into a selectively-shared memory to allow secure communications among (or between) related or unrelated applications. This principle applies to one-to-one sharing between applications or one-to-multiple sharing among applications.

A computing device that restricts communications between unrelated applications is described herein. The computing device can include a paste memory element in which a file system is imposed on the paste memory element. The computing device can also include a processing unit that is communicatively coupled to the paste memory element. The processing unit can be configured to write data associated with a first unrelated application to the paste memory element in compliance with the file system and to retrieve the data associated with the first unrelated application from the paste memory element in compliance with the file system and on behalf of the second unrelated application.

The computing device may also include an encryption engine, which can be configured to encrypt the data associated with the first unrelated application. The encryption engine can be further configured to decrypt the encrypted data associated with the first unrelated application on behalf of the second unrelated application.

As an example, the first unrelated application and the second unrelated application may be secure applications. As another example, the first unrelated application can be assigned a first certificate that is signed by a first entity, and the second unrelated application can be assigned a second certificate that is signed by a second entity. The second entity, for example, may not be under the direction or control of the first entity.

In one embodiment, the paste memory element can be a persistent memory element that enables data stored therein to survive a rebooting process. The processor may be further configured to impose a namespace for the paste memory element. In one example, the processor can also be configured to capture a snapshot of data stored in the paste memory element and store the snapshot of data to a remote location.

A computing device that is capable of storing unrelated applications is also described herein. The computing device can include a display that displays a first unrelated application and a second unrelated application in which communications between the first and second unrelated applications are restricted. The computing device may also have a memory element and a processing unit that can be communicatively coupled to the display and the memory element. The processing unit can be configured to impose a file system on the memory element in which the first unrelated application and the second unrelated application are compatible with the file system. The processor can also be configured to—through the file system—write data associated with the first unrelated application to the memory element and retrieve the data associated with the first unrelated application from the memory element on behalf of the second unrelated application.

As an example, the memory element can be a custom paste memory element that is segmented into multiple data blocks. The computing device may also include an encryption engine, which can be configured to encrypt the data that is associated with the first unrelated application and to decrypt the encrypted data on behalf of the second unrelated application. As another example, the unrelated applications may have different certificates assigned to them such that different entities sign the assigned certificates.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system that is capable of supporting communications among unrelated applications.

FIG. 2 illustrates an example of a method for enabling communications among unrelated applications.

FIG. 3 illustrates an exemplary representation of data exchange between two or more unrelated applications.

FIG. 4 illustrates an exemplary representation of a securitization process.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged between the components on a unidirectional or bidirectional (or multi-directional) manner, either wirelessly, through a wired connection or a combination of both. A “computing device” is defined as a component that is configured to perform some process or function for a user and includes both mobile and non-mobile devices. The terms “computer program medium” and “computer readable medium” are defined as one or more components that are configured to store instructions that are to be executed by a processing unit.

An “application” is defined as a program or programs that perform one or more particular tasks on a computing device. Examples of an application include programs that may present a user interface for interaction with a user or that may run in the background of an operating environment that may not present a user interface while in the background. The term “operating system” is defined as a collection of software components that directs a computing device's operations, including controlling and scheduling the execution of other programs and managing storage, input/output and communication resources. A “processing unit” is defined as one or more components that execute sets of instructions, and the components may be disparate parts or part of a whole unit and may not necessarily be located in the same physical location. The term “memory” or “memory element” is defined as one or more components that are configured to store data, either on a temporary or persistent basis. A “paste memory element” is defined as a memory element that is configured to receive data from a first application or first component (directly or indirectly) for possible eventual retrieval by that first application, first component or a second application or second component. An “interface” is defined as a component or a group of components that enable(s) a device to communicate with one or more different devices, whether through hard-wired connections, wireless connections or a combination of both. A “transceiver” is defined as a component or a group of components that transmit signals, receive signals or transmit and receive signals, whether wirelessly or through a hard-wired connection or both.

The term “unrelated applications” is defined as two or more applications that have no special permissions for sharing or managing data between (or among) them or are otherwise restricted from sharing or exchanging data in an unfettered or substantially unfettered and secure manner, either based on their construction or the environment in which they are installed (or both). For example, unrelated applications may be two or more applications that run as separate processes within an operating system. The term “file system” is defined as an abstraction that is used to organize, store and retrieve data. The term “secure application” is defined as an application that has been modified to restrict communications between the application and unauthorized programs or devices, restrict operation of the application based on policy or to alter, augment or add features associated with the operation of the application. The term “encryption engine” is defined as a component or a group of components that encrypt data, decrypt data or encrypt and decrypt data.

As explained earlier, because of security issues, applications that are installed on a mobile device are generally restricted from communicating with one another and any allowed exchanges are not performed in a secure manner. While addressing a valid concern, this arrangement drastically reduces the functionality of the applications.

A system and method of enabling communications among unrelated applications is described herein to address this problem. In particular, in an environment of a computing device that restricts communications among unrelated applications, a paste memory element can be identified, and a file system can be imposed on the identified paste memory element. The file system may be compatible with the unrelated applications such that a first unrelated application is capable of storing data in the paste memory element using the imposed file system and a second unrelated application is capable of accessing the stored data using the imposed file system. Both the first and second unrelated applications may be, for example, secure applications that are associated with a secure framework, and the paste memory element can be pre-existing memory of the computing device. The data that is stored in the paste memory element may be encrypted.

As such, the method and system provide a way for applications that may face significant restrictions on interprocess communications to exchange data with one another in a secure manner, while ensuring the integrity of the applications and the computing device that are involved. Moreover, minimal effort is required to implement such a system into the computing device.

Referring to FIG. 1, an example of system 100 that supports communications among unrelated applications is shown. A computing device 105 may be part of the system 100, and the device 105 may include a processing unit 110, a memory element 115 and a paste memory element 120. In one arrangement, the paste memory element 120 may be part of the memory element 115—although it may also be a separate and distinct unit—and may be communicatively coupled to the processing unit 110. As an example, the paste memory element 120 may be configured to accept and store data from a first application and enable the first application or a second application to retrieve this data. This process is sometimes referred to as a copy-and-paste operation, although it must be understood that the description herein is not limited to the simple temporary storage of text for later pasting. In fact, virtually any type of data may be placed in the paste memory element 120 for later retrieval.

The computing device 105 may also include an encryption engine 125, a display 130 and a transceiver 135, each of which may be communicatively coupled to the processing unit 110. The encryption engine 125 may selectively encrypt data associated with various applications and subsequently decrypt such data on behalf of other applications. Those skilled in the art will appreciate that virtually any type of encryption scheme may be employed here. The display 130 may present any suitable combinations of user interface elements to a user and may also provide a medium for data entry, such as through the use of a touchscreen. In addition, the transceiver 135 can be configured to support virtually any type of communications, including wireless or wired and local or wide area connections. As those skilled in the art will appreciate, multiple transceivers 135 may be part of the computing device 105 to support multiple communication protocols or standards. The computing device 105 may be a wireless device, such as a smartphone, tablet or a laptop, although it may also be a device that is coupled to some hard-wired connection, such as a desktop computer or a server.

The system 100 may also include an application repository 140, a network 145 and a remote storage unit 150. The network 145, for example, may be comprised of any suitable combination of components to enable any type of wireless or wired communications. In fact, the network 145 may comprise multiple networks, each working in tandem to support communications between the computing device 105 and the application repository 140, the remote storage unit 150 or some other component. In one arrangement, the application repository 140 may be any combination of components that are configured to offer applications for download to the computing device 105. The applications that are offered at the application repository 140 may be developed by or for various parties, thus providing a wide variety of applications to the user of the computing device 105. As will be explained below, the computing device 105 may store data at the remote storage unit 150 for later retrieval.

In one example, the computing device 105 may be a managed device, which enables a party to control certain aspects of the device 105, including the type of content that may be delivered to the device 105. Earlier presentations have been provided that illustrate a solution that describes some of these techniques, such as in U.S. patent application Ser. No. 13/179,513, filed on Jul. 9, 2011, which is incorporated by reference herein in its entirety.

Referring to FIG. 2, a method 200 of enabling communications among unrelated applications is shown. It is important to note that the method 200 may include additional or even fewer steps or processes in comparison to what is illustrated in FIG. 2. Moreover, the method 200 is not necessarily limited to the chronological order that is shown in FIG. 2. In describing the method 200, reference may be made to FIG. 1, although it is understood that the method 200 may be practiced with any other suitable systems and components.

At step 205, a paste memory element may be identified, and a file system may be imposed on the paste memory element, as shown at step 210. As part of this imposition, the paste memory element may be segmented into a plurality of data blocks, as shown at step 215. At step 220, a first unrelated application may be installed on a computing device, and at step 225, a second unrelated application may be installed on the computing device.

Referring to FIG. 1, the computing device 105 may present an environment that restricts or substantially restricts communications among unrelated applications. The phrase “restricts communications” is defined as a condition in which the unfettered exchange of data is not available or applications may not have certain permissions for sharing or managing data with respect to another application or service and any communications that are permitted are not done in a secure manner. For example, a first unrelated application may not be able to freely exchange data with a second unrelated application and any exchange that is allowed is open to other unrelated applications. This condition may be based on the construction of the applications themselves, the rules of the environment in which the applications are operating or a combination of both. As part of a solution, the paste memory element 120 of the device 105 can be identified and can have a file system imposed on it. Any suitable structure for the file system may be employed here. In one example, however, the file system can be a block file system and can essentially segment the paste memory element 120 into a plurality of data blocks for storing various types of data associated with unrelated applications. Thus, as will be explained further, a virtual file system is presented here that enables unrelated applications to share data among one another, data which may be encrypted to ensure it is not accessed by an unauthorized application or service.

Almost all operating systems provide a volatile memory element that enables a user to copy data and paste it into the memory element for later retrieval. In some of these environments, it is also possible to create custom memory elements for copying and pasting and to configure them as persistent memory elements, meaning that the data stored in them may survive reboots or other interruptions to the operation of the memory element. In one arrangement, as part of the identification of a paste memory element, any number of custom paste memory elements can be created to carry out the solutions presented herein, with the file system being imposed on these elements. Moreover, these custom paste memory elements may be configured to be persistent memory elements. It is understood, however, that the memory element(s) used for facilitating data exchange among unrelated applications may be any memory element that is part of the computing device. In particular, such memory element is not limited to being a paste memory element and does not have to be persistent in nature.

Whatever its form may be, the designation, creation and allocation of the paste memory element 120 may be predetermined or dynamic in nature. For example, the requirements for storage may be predetermined, and the paste memory element 120 may be created and configured prior to the exchange of data taking place. In another example, the requirements for storage may not be immediately known, and the paste memory element 120 may be set up after such information is obtained. For example, if it is determined that the amount of space available for storage is insufficient and must be expanded, then steps can be taken to allocate additional memory for the data exchange.

Referring back to FIG. 1, the computing device 105 may be configured to download and install a plurality of applications. In one arrangement, the computing device 105 can obtain these applications from the application repository 140, which may be an electronic storefront that specializes in the presentation and delivery of applications, although applications may be received from any other suitable source. The repository 140 may be capable of offering a wide variety of applications, with many of them being generated by or for different entities. As noted earlier, the installed applications may be considered unrelated applications such that they are prevented from freely exchanging data or communicating with one another and any permitted exchanges are not done in a secure manner. This condition may be based on the construction of the applications, the operating environment in which they are installed or both. In addition, as is common with such applications, they may be signed with different certificates, such that a first unrelated application may have a certificate that is signed by a first entity and a second unrelated application may have a different certificate signed by a second entity. In one arrangement, the second entity may not be under the direction or control of the first entity.

Referring back to FIG. 2, at step 230, data that is associated with the first unrelated application may be encrypted and stored in the paste memory element. At step 235, the data from the first unrelated application may be retrieved and decrypted on behalf of the second unrelated application.

For example, using the file system imposed on the past memory element 120, a first unrelated application may be able to exchange data in a secure manner with a second unrelated application. To help explain this concept, reference will be made to FIG. 3, which illustrates an exemplary representation of this process. Here, a plurality of unrelated applications 155—App₁, App₂ and App₃—is installed on the computing device 105. In this example, the unrelated applications 155 may face some restriction that prevents them from communicating with one another in a meaningful (and secure) way. As another example, the unrelated applications 155 may each have a different certificate attached to them—correspondingly represented by the symbols C₁, C₂ and C₃, although it is understood that the description here is certainly not limited to this particular scenario. In addition, the paste memory element 120 is shown here as having been segmented into a plurality of data blocks 160, which may be arranged by the file system imposed on the paste memory element 120. Through the file system, the data associated with, for example, the first unrelated application App₁ can be written to one or more of the data blocks 160 of the paste memory element 120. In one arrangement, the encryption engine 125 can encrypt the data that is written to the memory element 120. Encrypting the data can ensure that only select applications are permitted to access the data that is stored in the memory element 120.

At some point, one of the other unrelated applications 155, such as unrelated application App₂, may wish to retrieve the data associated with the first unrelated application App₁. Through the file system imposed on the paste memory element 120, the data can be retrieved from the memory element 120, and the encryption engine 125 can decrypt the data and pass it on to the second unrelated application App₂. Although encryption of the data is described here, it is important to note that it is not necessary to do so, as the unrelated applications 155 may store and exchange unencrypted data.

It must also be noted that the arrangement described here can permit virtually any number of unrelated applications to share data in a secure manner. For example, the paste memory element 120, via the virtual file system, may enable an unrelated application 155 to share data securely with a single (different) unrelated application 155 or multiple unrelated applications 155. In fact, any number of unrelated applications 155 may be able to communicate securely with any number of other unrelated applications 155 through this scheme.

To facilitate the encryption of data associated with an application, keys may be generated and exchanged between applications. For example, if the first unrelated application App1 is launched, a user or some other entity may be required to provide some type of verification information, such as a personal identification number or a biometric sample, like a fingerprint scan. In one embodiment, a key can be generated based on the verification information that is provided, and this key can be used to carry out the encryption. If the user closes the first unrelated application App₁ and then re-launches it, this same key can be used to decrypt the data if it is retrieved from the paste memory element 120. Similarly, if the user closes the first unrelated application App₁ following the encryption and writing of its data to the paste memory element 120 and launches the second unrelated application App₂, the first application App₁ may share this key with the second application App₂ to enable the second application App₂ to obtain the decrypted data. In this case, it may not be necessary for the user (or other entity) to provide the verification information again. This key exchange may occur between any suitable number and type of unrelated applications, as represented in FIG. 3.

To address security concerns, however, some restrictions may be placed on this process. For example, an unrelated application may be blocked from sharing a key with one or more other unrelated applications, and any suitable type of criteria for determining whether to block such sharing may be considered. For example, some unrelated applications may be blacklisted to prevent the release of keys to such applications. Moreover, a time limit may be imposed on the key exchange between unrelated applications. Consider the example described above. Once the first unrelated application App₁ generates its key, a time limit may be imposed on the sharing (or re-use) of that key. For example, once the first unrelated application App₁ is closed, a time period may begin to toll, such as one minute or some other predetermined amount of time. If the first unrelated application App₁ is re-launched or the second unrelated application App₂ is launched before this time expires, the first application App₁ may re-use the key or the first application App₁ may share this key with the second application App₂. If, however, the re-launch of the first application App₁ or the launch of the second application App₂ occurs after the expiration of the time period, then the first application App₁ or the second application App₂ may need to generate a new key to retrieve the data. This new key may also be based on verification information provided by the user or some other entity. Of course, if desired, a more restrictive procedure may be used, and upon launch, each unrelated application 155 may be required to generate a key, i.e., no key sharing may be permitted.

Other steps may be taken to protect the data stored in the paste memory element 120 and the unrelated applications 155. For example, a derived and unpredictable namespace may be imposed on the paste memory element 120, particularly if the paste memory element 120 is a custom paste memory element created in the fashion previously described. In addition, the namespace may be imposed on the unrelated applications 155 that may have access to the paste memory element 120. This namespace encapsulation may prevent unauthorized applications from accessing the data stored in the paste memory element 120. One way in which a namespace may be imposed on unrelated applications 155 will be presented later.

Referring back to FIG. 2, at step 240, a snapshot of data may be captured and stored remotely. As noted earlier, the system 100 of FIG. 1 may include a remote storage unit 150. In one arrangement, a snapshot may be taken of data associated with an unrelated application 155 and that is stored in the paste memory element 120. Moreover, the computing device 105 can transfer this snapshot of data to the remote storage unit 150 or some other suitable component. Thus, the data associated with any number of unrelated applications 155 may be backed-up remotely and can be retrieved in the event of an issue at the computing device 105 or for some other reason.

Recent advances have been realized in application configuration and management. In particular, applications may be modified to enable the applications to be managed in a certain way or to achieve new functionalities, a process commonly referred to as wrapping or securitizing an application. Referring to FIG. 4, a representation 400 of the wrapping or securitization process is illustrated. Here, a conventional or target application 155 is shown in which the target application 155 is developed for operating system 405 and calls system APIs 410. At this point, the target application 155 may be considered a non-secure application. The target application 155 can be submitted to a securitization agent 420, and the securitization agent 420 can subject the target application 155 to the wrapping process to generate a secure application 425. The securitization agent 420 can include any suitable number and type of software and hardware elements to carry out the securitization process.

In view of this procedure, the secure application 425 may still maintain its affiliation with the operating system 405 and may still call the system APIs 410. The overall utility of the secure application 425, however, is increased because one or more intercepts 430 may be interposed on the system APIs 410. These intercepts may be representative of any number of policies that are set forth by a party in control of the secure application 425 and of any new or modified functionalities that are realized from the wrapping process.

It is important to note that securitizing an application 155 does not just add a dynamic library to an executable by simply modifying the header of an executable, a process that is easily undone and may violate development agreements associated with the application; rather, it can repackage the application so that the injected code is physically inseparable from the original code. This method prevents secure applications that may be modified by third parties from running within a secure environment.

In addition, the wrapping or securitization process can preserve all the normal functions and APIs of a platform, while ensuring that protected information is handled securely. Application developers do not have to create applications or modify existing applications to accommodate this procedure and are not required to use any custom APIs or lose any functions associated with their applications. Calls to data sharing or data storage APIs may be automatically intercepted to ensure that sensitive enterprise data is handled appropriately. As such, secure applications may share data in the normal methods that are available on a given platform, but secure applications may not be able to share data with non-secure applications.

There are several ways to carry out the process of securing applications. The first scheme primarily focuses on byte-code injection, in which byte-code API calls are replaced with intercepts. As an example, this method is particularly applicable to—but certainly not limited to—certain applications formatted for the Android operating system developed by Google, Inc. of Mountain View, Calif. The second scheme chiefly centers on linking in replacement calls for native object code. This latter method is useful for applications that use native methods, such as Android applications that rely on native code (i.e., they do not run under a virtual machine) and applications developed for iOS, a mobile operating system developed by Apple, Inc. of Cupertino, Calif. Of course, other methods for creating a secure application may be employed here. Additional information on these concepts is presented in U.S. patent application Ser. No. 13/626,470, filed on Sep. 25, 2012, which is incorporated by reference herein in its entirety.

In view of the wrapping process, the unrelated applications described above may be secure applications. In other words, the unrelated applications may be modified to increase their functionality over their original designs. As one non-limiting example, a first unrelated secure application may be restricted from launching if the computing device 105 is outside a predetermined location or is no longer connected to a certain network. A second unrelated application, as another non-limiting example, may be restricted from launching outside a predetermined time period, such as regular business hours. As can be seen, virtually any type of configuration may be imposed on these secure and unrelated applications.

As may be expected, the configurations of unrelated secure applications may change periodically. The arrangement presented herein, however, enables these unrelated secure applications to access a central location to ensure that their configurations are current. For example, current configuration information for one or more unrelated secure applications may be loaded into the paste memory element 120 using the file system referenced above. At launch or when running in the background, an unrelated secure application may access the paste memory element 120 to ensure that the configuration of the secure application is current. As an example, as part of the configuration for the unrelated secure application, one or more policies may be imposed on the application, such as the geographical or temporal restrictions mentioned above. If the parameters associated with these restrictions are modified, the configuration stored in the paste memory element 120 can be updated, and the application may retrieve this information. As such, the unrelated application can be updated with these new policies. For increased efficiency, the same configurations data may be applicable to multiple unrelated applications, although the description herein is not necessarily limited to this arrangement.

In one embodiment, the unrelated applications may be re-mapped during the wrapping process to interact with and support the file system that is imposed on the paste memory element 120. For example, this process may include re-mapping the reading and writing commands of the unrelated application to the file system. As previously noted, the namespace imposed on the paste memory element 120 may also be imposed on the unrelated applications. This procedure can be carried out, for example, when the unrelated applications undergo the wrapping process. The use of secure applications and namespace enforcement can also facilitate the sharing of keys for the encryption/decryption of data described above. That is, these schemes can ensure that only authorized applications may be part of a secure workspace that provides access to a common memory element and a virtual file system for accessing the element, which presents a much safer environment for sharing keys.

Although unrelated applications that are secure applications may take advantage of the principles presented herein, this description is not so limited. That is, it is important to note that unrelated applications that have not undergone the wrapping process may exchange data with one another using a file system imposed on a memory element.

There are several other principles that should be addressed here. In particular, it is not necessary to impose a file system on the paste memory element. That is, applications that wish to exchange data may do so using the paste memory element without the use of a file system. Moreover, applications that can take advantage of data exchange using the paste memory element, with or without a file system, do not have to be unrelated to one another. That is, any application may provide encrypted data to the paste memory element, and any other authorized application may access and decrypt the data. This concept applies to both secure and unsecure applications and related and unrelated applications.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method of enabling communications among unrelated applications, comprising:
in an environment of a computing device that restricts communications among unrelated applications, identifying a paste memory element; and
imposing a file system on the identified paste memory element, wherein the file system is compatible with the unrelated applications such that a first unrelated application is capable of storing data in the paste memory element using the imposed file system and a second unrelated application is capable of accessing the stored data using the imposed file system.

2. The method according to claim 1, wherein the identified paste memory element is a general memory element that is part of the computing device or a custom memory element that is created as part of identifying the paste memory element.

3. The method according to claim 2, further comprising imposing a namespace on the custom memory element.

4. The method according to claim 1, wherein the first unrelated application is further capable of storing encrypted data in the paste memory element using the imposed file system and the second unrelated application is further capable of accessing the encrypted stored data using the imposed file system.

5. The method according to claim 4, further comprising providing a key to the second unrelated application or generating the key through the second unrelated application to enable the second unrelated application to access the encrypted stored data.

6. The method according to claim 1, wherein the first unrelated application and the second unrelated application are secure applications.

7. The method according to claim 1, wherein the first unrelated application has a certificate that is signed by a first entity and the second unrelated application has a certificate that is signed by a second entity.

8. The method according to claim 1, wherein the paste memory element is a persistent paste memory element such that data stored in the paste memory element survives a rebooting process.

9. The method according to claim 1, further comprising segmenting the paste memory element into a plurality of data blocks and the file system imposed on the paste memory element is structured as a corresponding block file system.

10. The method according to claim 1, wherein data that is stored in the identified paste memory element comprises configuration data that at least includes policies that are related to the operation of the first unrelated application or the second unrelated application.

11. A method of enabling communications among unrelated applications, comprising:
installing a first application on a computing device;
installing a second application on the computing device;
storing data associated with the first application in a paste memory element through a file system imposed on the paste memory element;
accessing the stored data using the second application through the file system imposed on the paste memory element;
wherein the first application and the second application are unrelated applications and the computing device is configured to restrict communications between unrelated applications.

12. The method according to claim 11, further comprising:
encrypting the data to be stored in the paste memory element that is associated with the first unrelated application; and
decrypting the stored data as part of accessing the stored data using the second unrelated application.

13. The method according to claim 11, wherein the first application has a certificate that is signed by a first entity and the second application has a certificate that is signed by a second entity.

14. The method according to claim 11, wherein the file system is a block file system and the paste memory element is segmented into multiple data blocks.

15. The method according to claim 11, wherein the first application and the second application are secure applications that have been modified to increase their functionality over their original designs.

16. The method according to claim 11, wherein the paste memory element is a persistent paste memory element.

17. The method according to claim 11, further comprising capturing a snapshot of data stored in the paste memory element and saving a copy of the snapshot of data to a remote location.

18. A method of enabling communications among unrelated applications, comprising:
writing data to a memory element with a first unrelated application; and
accessing the data from the memory element with a second unrelated application;
wherein the first unrelated application and the second unrelated application are installed on a computing device that presents an environment in which unrelated applications are restricted from sharing data with one another and a file system is imposed on the memory element to facilitate the exchange of data between the first unrelated application and the second unrelated application.

19. The method according to claim 18, further comprising:
encrypting the data that is written to the memory element from the first unrelated application; and
decrypting the data that is accessed from the memory element that is accessed by the second memory element.

20. The method according to claim 18, wherein the memory element is a paste memory element that enables copy and paste operations on the computing device.

21. The method according to claim 18, wherein the first unrelated application and the second unrelated application are secure applications.

22. The method according to claim 21, wherein the first unrelated application and the second unrelated application are re-mapped to interact with the file system imposed on the memory element.

23. The method according to claim 18, wherein a namespace is also imposed on the memory element.

24. A computing device, wherein the computing device restricts communications between unrelated applications, comprising:
a paste memory element, wherein a file system is imposed on the paste memory element; and
a processing unit, wherein the processing unit is communicatively coupled to the paste memory element, wherein the processing unit is configured to:
write data associated with a first unrelated application to the paste memory element in compliance with the file system; and
retrieve the data associated with the first unrelated application from the paste memory element in compliance with the file system and on behalf of the second unrelated application.

25. The computing device according to claim 24, further comprising an encryption engine, wherein the encryption engine is configured to encrypt the data associated with the first unrelated application.

26. The computing device according the claim 25, wherein the encryption engine is further configured to decrypt the encrypted data associated with the first unrelated application on behalf of the second unrelated application.

27. The computing device according to claim 24, wherein the first unrelated application and the second unrelated application are secure applications.

28. The computing device according to claim 24, wherein the first unrelated application is assigned a first certificate that is signed by a first entity and the second unrelated application is assigned a second certificate that is signed by a second entity.

29. The computing device according to claim 28, wherein the second entity is not under the direction or control of the first entity.

30. The computing device according to claim 24, wherein the paste memory element is a persistent memory element that enables data stored therein to survive a rebooting process.

31. The computing device according to claim 24, wherein the processor is further configured to impose a namespace on the paste memory element.

32. The computing device according to claim 24, wherein the processor is further configured to:
capture a snapshot of data stored in the paste memory element; and
store the snapshot of data to a remote location.

33. A computing device that is capable of storing unrelated applications, comprising:
a display that displays a first unrelated application and a second unrelated application, wherein communications between the first and second unrelated applications are restricted;
a memory element; and
a processing unit that is communicatively coupled to the display and the memory element, wherein the processing unit is configured to:
impose a file system on the memory element, wherein the first unrelated application and the second unrelated application are compatible with the file system;
through the file system, write data associated with the first unrelated application to the memory element; and
through the file system, retrieve the data associated with the first unrelated application from the memory element on behalf of the second unrelated application.

34. The computing device according to claim 33, wherein the memory element is a custom paste memory element that is segmented into multiple data blocks.

35. The computing device according to claim 33, further comprising an encryption engine that is configured to encrypt the data that is associated with the first unrelated application and to decrypt the encrypted data on behalf of the second unrelated application.

36. The computing device according to claim 33, wherein the unrelated applications have different certificates assigned to them such that different entities sign the assigned certificates.
